(19) United States
(12) Patent Application Publication
(10) Pub. No.: US 2007/0006518 A1
(43) Pub. Date: Jan. 11, 2007

(54) Fishing lure with replaceable tail

(76) Inventor: Maumus F. Claverie III, Houston, TX (US)

Correspondence Address: John R. Casperson, PO Box 2174, Friendswood, TX, 77549, US

(21) Appl. No.: 11/175,872

(22) Filed: Jul. 6, 2005

(51) Int. Cl. A01K 85/00

(52) U.S. Cl. 43/42.22

(57) ABSTRACT

A fishing lure having a longitudinal axis and comprising a head section and a tail section serially connected along the longitudinal axis is disclosed. The head section is formed from a rigid material and has a front end and a back end portion. The back end portion is formed from generally opposed side wall portions. The tail section is formed from a flexible material and has a front end portion and a back end. The front end portion of the tail section is closely received by the back end portion of the head section. The tail section carries the hook, and is retained in position by a cross pin, and is easily replaced.

### BACKGROUND OF THE INVENTION

The invention relates to a fishing lure to be used for big game, especially marlin.

Hard bodied fishing lures are not well suited for marlin fishing, because they are very heavy when sized to appeal to marlin-sized fish, and their great weight enables a thrashing marlin to throw them. Large squid-type lures rigged to slide up the leader, or large rigged natural baits which disintegrate shortly after hook-up are more commonly used, as they offer the marlin less leverage to unhook himself.

One natural marlin prey fish which is not commonly used as a rigged natural bait is the dolphinfish, species Coryphaena hippurus. The bait presents two problems when trolled as a dead bait. The first is coloration. Live dolphin fish can be most any color of the rainbow, but dead ones are uniformly dreary gray. They do not look alive when rigged as a bait. The second problem is the way a rigged dolphinfish moves. It simply is not lifelike. Because a dolphinfish is relatively flat and tall in profile, it does not troll well, and is susceptible to spinning. Also, dolphinfish are stiff in death, because of their size and musculature.

I have experimented with softbodied dolphinfish-shaped lures with some success. The softbodied lure moves well and can be any desired color or color combination. It can be rigged to run reasonably true up to a speed of about 8 knots. However, the soft, broad head is just too flexible to run true at a higher speed, and 10-14 knots is a common trolling speed for marlin. Also, the lure is typically severely damaged on the strike, and has to be cut off and re-rigged, which is both expensive and time consuming.

Earlier attempts to combine a hard head with a soft tail have been made. One technique was to connect the two pieces with a T joint wherein the tail section has a T head and slide tranversely into a matching slot in the head. The configuration is not durable enough for large lures or large game fish, because of the softness of the tail section. Another attempt was simply to glue the tail section onto the head section with an adhesive, such as super glue (methylmethacrylate). This method is difficult to carry out on the high seas without complications, and furthermore makes it difficult to replace the tail section.

A dolphin-fish or other prey fish type lure which has sufficient rigidity to troll at more than 10 knots, is formed from a flexible material so that it moves in a lifelike manner and is easily colored, slides away from the fish if it jumps, and is easier and less expensive to re-rig than a totally softbodied lure would be very desirable.

It is an object of this invention to provide such a fishing lure.

### SUMMARY OF THE INVENTION

In accordance with one embodiment of the invention, there is provided a fishing lure having a longitudinal axis and comprising a head section and a tail section serially connected along the longitudinal axis. The head section is formed from a rigid material and has a front end and a back end portion. The back end portion is formed from generally opposed side walls. The tail section is formed from a flexible material and has a front end portion and a back end. The front end portion of the tail section is closely received by the back end portion of the head section. A through-pin extending between the side walls passes at least partially through the front end portion of the tail section to reliably secure the head section to the tail section.

When the head section is made of hard plastic, it can be towed at high speed without being damaged by supporting it from behind in the conventional manner on a bead positioned on the leader and prevented from sliding back by a crimp. A large hook is positioned on the end of the leader appropriately spaced from the crimp to properly rig the tail section. The tail section provides the desired color and lifelike lure action, and it is protected from the rigors of being towed by the hard head section and cross pin. If it becomes damaged, it is easily replaced. The hard section and leader can be reused with replacement tail sections an indefinite number of times.

### BRIEF DESCRIPTION OF THE DRAWINGS

FIG. 1 is a pictorial illustration of one embodiment of the invention.

FIG. 2 is an exploded view of the invention show in FIG. 1.

FIG. 3 is a side view of the invention shown in FIG. 1, showing internal passages.

FIG. 4 is a longitudinal sectional view of the invention as shown in FIG. 3 when taken along cut lines 4-4.

FIG. 5 is a side view of a portion of the invention shown in FIG. 3 with one of the features shown in variable orientations.

FIG. 6 is a pictorial illustration of another embodiment of the invention, partly exploded.

FIG. 7 is a longitudinal sectional view of the invention shown in FIG. 6.

FIG. 8 is a pictorial illustration of another embodiment of the invention.

FIG. 9 is a side view of a portion of the invention shown in FIG. 8.

FIG. 10 is a pictorial illustration of another embodiment of the invention.

FIG. 11 is a pictorial illustration of an embodiment of FIG. 10 after partial assembly.

FIG. 12 is a cross section of the embodiment of FIG. 11 in full assembly.

### DETAILED DESCRIPTION OF THE INVENTION

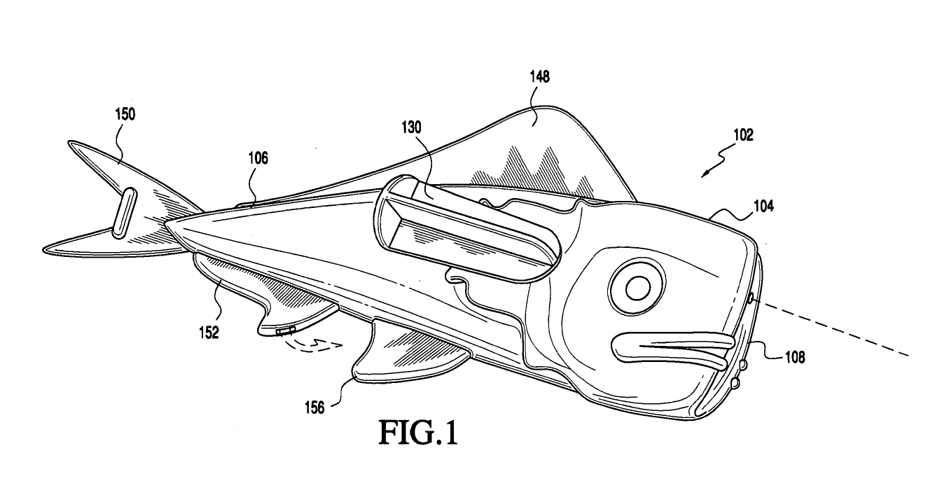

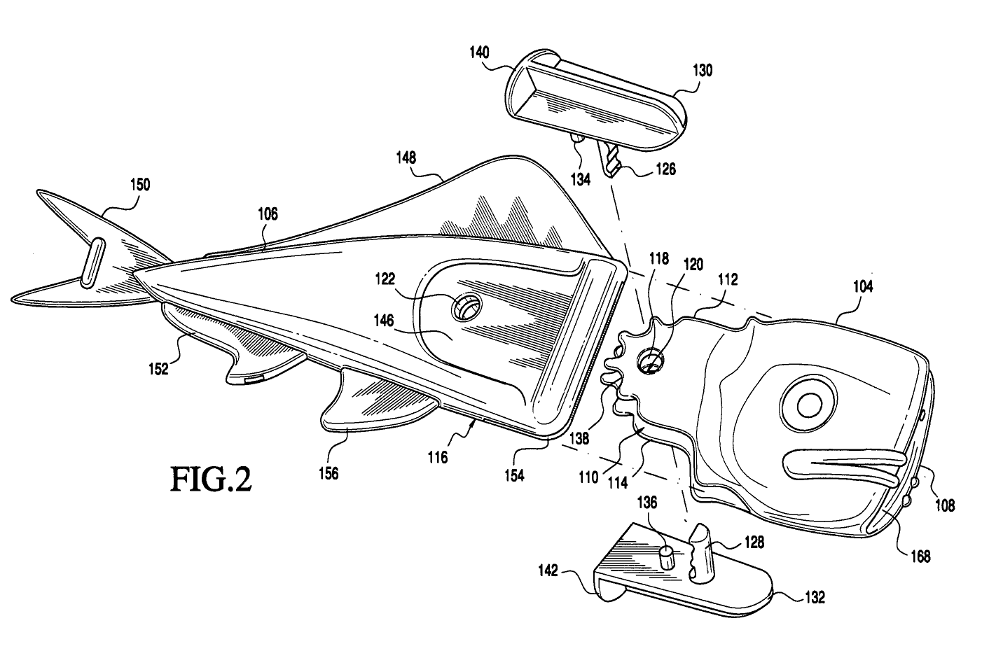

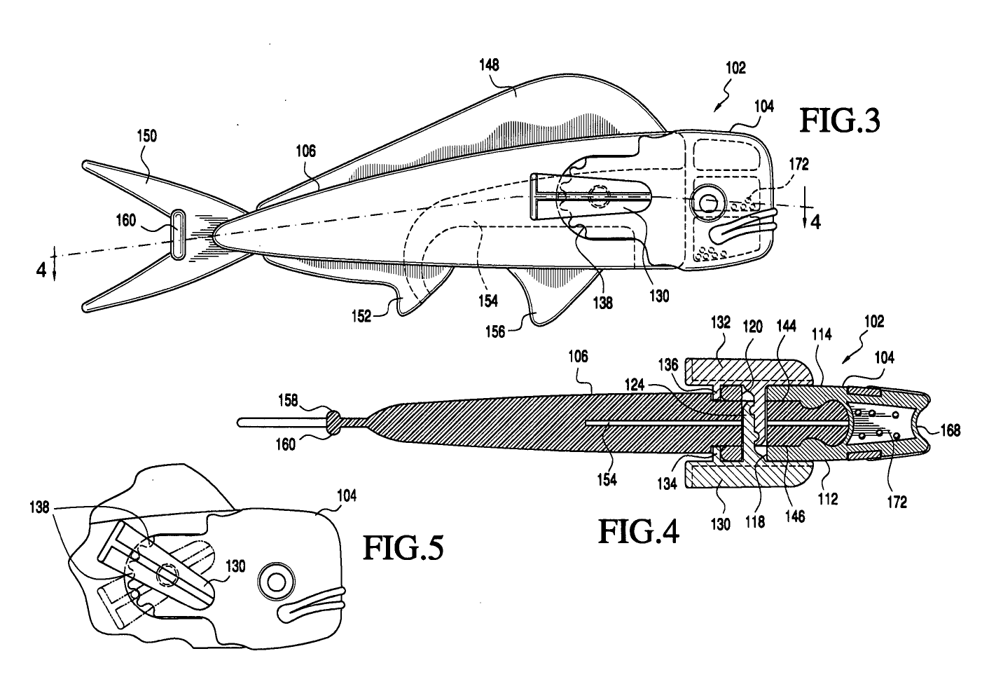

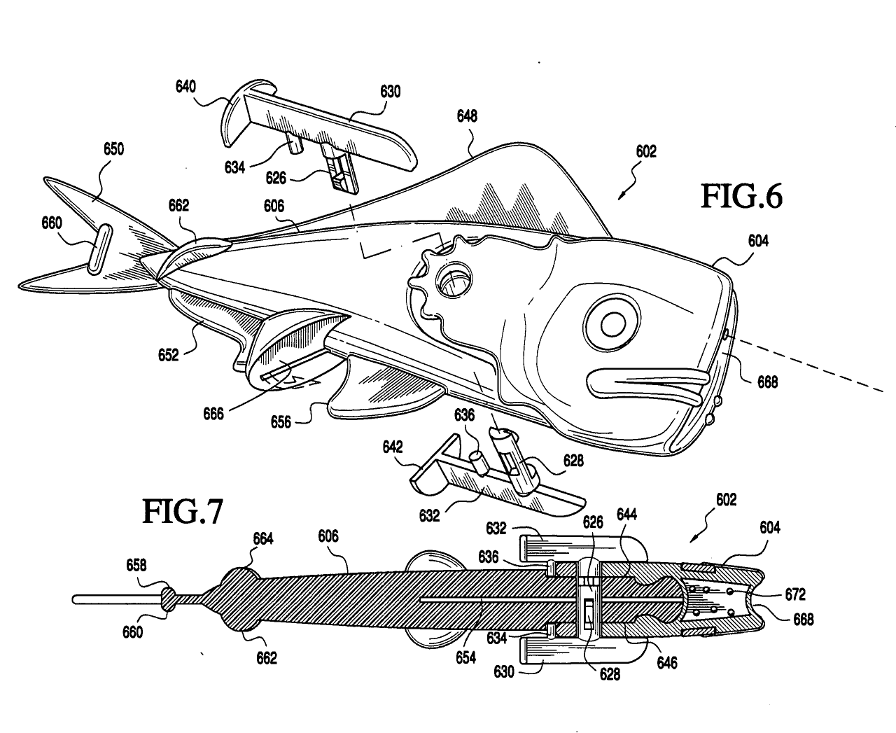

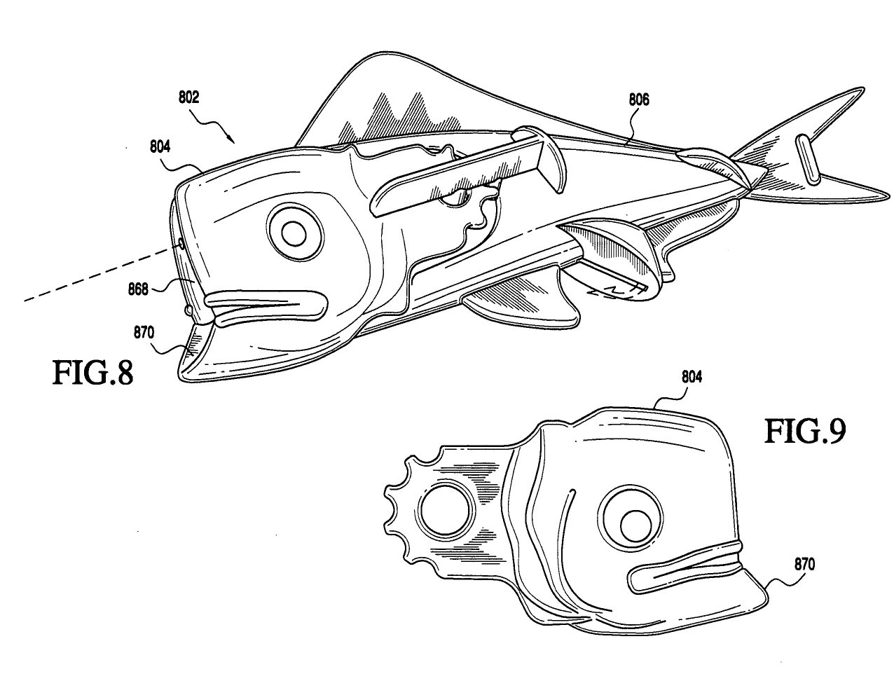

The invention as illustrated by the Figures comprises a fishing lure having a longitudinal axis and comprising a head section and a tail section serially connected along the longitudinal axis. In FIGS. 1-5, the fishing lure 102 has head section 104 and tail section 106. In FIGS. 6-7, the fishing lure 602 has head section 604 and tail section 606. In FIGS. 8-9, the fishing lure 802 has head section 804 and tail section 806. As between these groups of Figures, the invention as shown in FIGS. 6-7 differs from that shown in FIGS. 1-5 in the construction of the tail section, and also in the construction of the interlocking pins with side fins. The invention as shown in FIGS. 8-9 differs from that shown in FIGS. 6-7 in the construction of the head section. The invention as shown in FIGS. 1-12 differs from that shown in FIGS. 8-9 in the position of the through-pin and side walls. The invention will be described generally with reference to FIGS. 1-5 unless otherwise noted.

The head section of the fishing lure is formed from a rigid material and has a front end 108 and a back end portion 110. The back end portion is formed from generally opposed side walls 112 and 114. The tail section is formed from a flexible material, preferably soft plastic, and has a front end portion 116 and a back end. The front end portion of the tail section is closely received by the back end portion of the head section.

Certain aspects of the invention can be employed with natural baits, preferably whole fish such as tuna, mackerel, ballyhoo, mullet and dolphinfish. These aspects can be similarly practiced with artificial copies of whole baits. For example, artificial whole dolphinfish, mullet and ballyhoo are commercially available. In this instance, the head of the fish or copy thereof constitutes the front end of the tail section, and the back end portion of the head section is shaped to accommodate the head of the bait. The cross-pin is preferably positioned so as to pass through the eye sockets of a natural bait. The opposed side walls can be portions of a continuous side wall that defines a space to receive the head of the bait.

The generally opposed side walls in one embodiment of the invention are generally parallel and define a pair of aligned boreholes 118, 120. The tail section defines a borehole 122 which is aligned with the boreholes defined by the side walls. The fishing lure further comprises a cross-pin 124 positioned in the boreholes to retain the tail section in the head section.

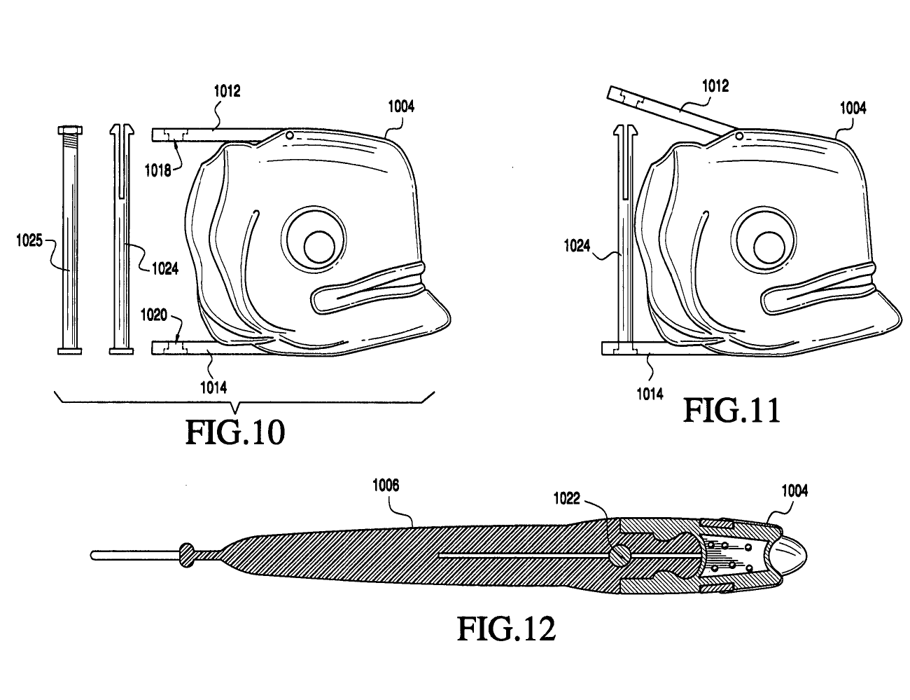

In the embodiment shown in FIGS. 1-9, the side walls extend along opposed side surfaces of the tail section and the cross pin extends generally horizontally through the body of the tail section. In the embodiment shown in FIGS. 10-12, the side walls 1012, 1014 extend along opposed top and bottom surfaces of the tail section and the cross pin 1024 extends generally vertically through a borehole 1022 through the body of the tail section. In the illustrated embodiment, at least one of the side walls 1012, 1014 is further hinged or sufficiently pliable to enable it to be swung out of the way when replacing the tail section 1006, although this is not always necessary. In FIGS. 10-12, the cross pin can be removable and positioned through opposed boreholes in the side walls, or it can be made integral with one of the side walls. Alternate embodiments of the cross pin, such as a bolt 1025 with a nut, or a pin with a cotter key or other locking device such as a lynch pin can be used as well. In the illustrated embodiment, pin 1024 snap locks into side wall 1012.

In the embodiment of FIGS. 1-9, the cross pin is preferably removable. A bolt and nut, or single locking pin can be used, or the cross-pin can be formed from a pair of complementary interlocking pin portions 126, 128, or interlocking pin portions 626, 628 (see FIG. 6). Where the tail section is formed of a resilient synthetic material the complementary interlocking pin portions are preferably biased into an interlocked position by the resilient material which defines the borehole. Preferably, each of the pair of complementary interlocking pin portions comprises a longitudinally split rod section having a face side and a semicylindrical back side, the face side having at least one protruding tooth and at least one depression, the at least one depression being for receiving the at least one tooth of the complementary pin portion. In the embodiment shown in FIGS. 1-5, the teeth and slots are elongated across the axis of the pin, whereas in the embodiment shown in FIGS. 6-7, the teeth and slots are elongated parallel to the axis of the pin.

In a preferred embodiment employing a horizonal pin as shown in FIGS. 1-9, each of the complementary interlocking pin portions is preferably formed from a rigid material and has a pin portion as above and can further be provided with a fin portion 130, 132, or fin portion 630,632 (see FIG. 6) The pin portions are received in the aligned boreholes. The fin portions protrude from an outer surface of the side wall to form a hydroplane for the fishing lure. Most preferably, the fin portions, when employed, resemble a pectoral fin.

Where employed, the fin portions are preferably flattened and extend generally normally from the pin portions. The fin portion can be described as having a length, a width, and a thickness and being oriented so that the width is generally parallel to a longitudinal axis of the pin portion and the length is generally normal to the longitudinal axis of the pin portion. In the embodiment shown in FIGS. 1-5, the fin portion is mounted to a base plate portion which is positioned parallel to the side wall outer surface, but this feature is eliminated from the device as shown in FIG. 6-7.

In the illustrated embodiment, each fin portion has a positioning tooth 134, 136 (634, 636 in FIG. 6) protruding from the fin portion in the same direction as the pin portion. The outer surface of each side wall forms at least one depression 138 (see FIG. 5) for receiving the positioning tooth and setting a hydrofoil angle for the fin portion. Each side wall has a trailing edge which defines a plurality of arcuately spaced apart depressions sized to receive the tooth to provide a plurality of hydrofoil angles. The desired angle is set when the fishing lure is assembled.

The fin portion further preferably has a leading edge and a trailing end. The leading edge is preferably streamlined and the trailing end is defined by a flow disrupter body 140, 142 (640, 642 in FIG. 6). Preferably, the flow disrupter body comprises a semicircular plate section positioned normally to the length of the fin portion with a curved edge facing away from the side wall, although other shapes could be used if desired.

The head section can generally be described in a preferred embodiment as in the shape of a fish head and the tail section, when in the embodiment of an artificial bait, can generally be described as in the shape of a headless fish. for example, a tuna, a mackerel, a mullet, a ballyhoo or a dolphinfish. The most preferred embodiment is generally in the shape of a dolphinfish, species Coryphaena hippurus. Dolphinfish are relatively flat, and a fishing lure in the caricature of a dolphinfish can be described as having a length, a height, and a width, and a height:width ratio which is in the range of 1.5:1 to 5:1. The length of the preferred embodiment lure is in the range of 20 to 80 centimeters, preferably in the range of 25 to 50 centimeters. The overall appearance of the fishing lure can be described as a caricature of a dolphinfish. Caricatures of other preyfish, such as tuna, mackerel, mullet and ballyhoo can be embodied by the invention as well.

In the horizonal pin embodiment, the forward portion of the tail section preferably has opposed, slightly recessed flats 144, 146 (644,646 in FIG. 7) for receipt by the head section to provide a relatively smooth outer surface for the fishing lure where the head section and the tail section come together. This feature can also be used in the vertical pin embodiment. A pair of opposed parallel grooves is formed in the recessed flats of the tail section for receiving opposed parallel facing ridges formed on an inner surface of each of the side walls.

The tail section further preferably defines a dorsal fin 148, a caudal fin 150, and an anal fin 152 (648,650 and 652 in FIG. 6). The tail section preferably further defines a slot 154 (654 in FIG. 7) leading from the front end to near the anal fin for receipt and positioning of rigging. Suitable rigging would comprise a hook and leader. Also preferably, the tail section further defines a pelvic fin 156, (656 in FIG. 6). The pelvic fin is positioned to reduce weed pickup when the fishing lure is in use.

The tail section preferably further defines a pair of opposed, oppositely-facing parallel ridges 158, 160 (658, 660 in FIG. 7) protruding outwardly from a location near the caudal fin and extending generally normal to the longitudinal axis. In the embodiment of the invention shown in FIGS. 6-7, the tail section further defines a pair of opposed ridges 662, 664 extending at an acute angle with respect to the longitudinal axis and protruding outwardly from a location near the caudal peduncle to provide upforce to the back end of the fishing lure when the lure is in use. The FIG. 6-7 embodiment also provides a relatively flat face 666 extending at an acute angle with respect to the longitudinal axis from a location near a front end of the anal fin to provide upforce to the back end of the fishing lure when the lure is in use.

In one embodiment, the head section preferably defines a shallow trough 168 (668 in FIG. 6) extending vertically along the front end of the head section. In the embodiment shown in FIGS. 8-9, the front end of the head section further defines a lower lip 870 to provide downforce to the front end of the fishing lure when the lure is in use. All embodiments preferably employ a rattle means 172, (672 in FIG. 7) embedded in the head section. Suitable rattles are well known in the fishing lure industry.

The fishing lure of the invention can generally have a length in the range of about 7 to about 70 cm. The artificial tail section is constructed of a rubbery polymer. For game fish having an expected weight in the range of about 4 to about 40 kg., a bait having a length in the range of about 7 cm to about 35 cm is expected to provide good results. For game fish having an expected weight in the range of about 40 kg to about 400 kg and beyond, a bait having a length in the range of about 20 cm to about 70 cm is expected to be more useful. The line used to rig the fishing lure can be of any desired construction, but marlin leader, which is a nylon monofilament having a breaking strength of at least a hundred pounds, such as 400 pounds, is preferred. The combination can be trolled at big game speeds, such as in the range of about 1 to about 20 knots, usually in the range of about 4 to about 14 knots. Due to the drag caused by the fishing lure, the use of heavy tackle, such as 50 pound class and heavier, is preferred.

While certain preferred embodiments of the invention have been described hereinabove, the invention is not to be construed as being so limited, except to the extent that such limitations are found in the claims.

What is claimed is:

1. A fishing lure having a longitudinal axis and comprising a head section and a tail section serially connected along the longitudinal axis,
said head section being formed from a rigid material and having a front end and a back end portion, the back end portion being formed from generally opposed side wall portions,
said tail section being formed from a flexible material and having a front end and a back end, a front end portion of the tail section being closely received by the back end portion of the head section between the side wall portions, and
at least one cross pin extending between the side wall portions and passing at least partially through the front end portion of the tail section for securing the tail section to the head section.

2. A fishing lure as in claim 1 wherein the side walls extend along opposed side surfaces of the tail section and the at least one cross pin is generally horizontally positioned.

3. A fishing lure as in claim 1 wherein the side walls extend along opposed top and bottom surfaces of the tail section and the at least one cross pin is generally vertically positioned.

4. A fishing lure as in claim 1 wherein at least one of the side walls is hingedly connected to the head section.

5. A fishing lure as in claim 1 wherein the cross pin is fixedly attached to one of the side walls.

6. A fishing lure as in claim 1 wherein
the generally opposed side wall portions define a pair of aligned boreholes, and
the tail section defines a borehole which is aligned with the boreholes defined by the side wall portions, and
the cross-pin is positioned in the boreholes to retain the tail section in the head section.

7. A fishing lure as in claim 1 wherein the cross pin is selected from the group consisting of a bolt, a cylinder, a self-locking pin, and a pair of interlocking pins.

8. A fishing lure as in claim 1 which forms a caricature selected from the group consisting of a dolphinfish, a tuna, a mackerel, a mullet, and a ballyhoo.

9. A fishing lure as in claim 1 wherein the cross-pin is formed from a pair of complementary interlocking pins, each of the pair complementary interlocking pins comprising a longitudinally split rod section having a face side and a semicylindrical back side, the face side having at least one protruding tooth and at least one depression, the at least one depression being for receiving the at least one tooth of the complementary pin section.

10. A fishing lure as in claim 9 wherein each of the complementary interlocking pins is formed from a rigid material and has a pin portion and a fin portion, the pin portion being received in the aligned boreholes, the fin portion protruding from an outer surface of the side wall to form a hydroplane for the fishing lure.

11. A fishing lure as in claim 10 wherein the fin portion has a positioning tooth protruding from the fin portion in the same direction as the pin portion, wherein an outer surface of each side wall forms at least one depression for receiving the positioning tooth and setting a hydrofoil angle for the fin portion.

12. A fishing lure as in claim 1 wherein a forward portion of the tail section has opposed, slightly recessed flats for receipt by the head section to provide a relatively smooth outer surface for the fishing lure where the head section and the tail section come together, and
wherein a pair of opposed parallel grooves are formed in the recessed flats of the tail section for receiving opposed parallel facing ridges formed on an inner surface of each of the side walls.

13. A fishing lure as in claim 1 wherein the tail section further defines a dorsal fin, a caudal fin, and an anal fin, and the tail section further defines a slot leading from the front end to near the anal fin for receipt and positioning of rigging.

14. A fishing lure as in claim 13 wherein the tail section further defines a pair of opposed, oppositely-facing parallel ridges protruding outwardly from a location near the caudal fin and extending generally normal to the longitudinal axis.

15. A fishing lure as in claim 14 wherein the tail section further defines a pair of opposed ridges extending at an acute angle with respect to the longitudinal axis and protruding outwardly from a location near the caudal fin to provide upforce to the back end of the fishing lure when the lure is in use.

16. A fishing lure as in claim 14 wherein the tail section further defines a relatively flat face extending at an acute angle with respect to the longitudinal axis from a location near a front end of the anal fin to provide upforce to the back end of the fishing lure when the lure is in use.

17. A fishing lure as in claim 14 wherein the head section further defines a shallow trough extending vertically along the front end of the head section.

18. A fishing lure as in claim 17 wherein the front end of the head section further defines a lower lip to provide downforce to the front end of the fishing lure when the lure is in use.
